(19) United States
(12) Patent Application Publication
(10) Pub. No.: US 2011/0213053 A1
(43) Pub. Date: Sep. 1, 2011

(54) NEW-TYPE PAPERMAKING WET-END DEFOAMER

(75) Inventors: Fei Wu, Jiangsu (CN); Zhiping Cao, Jiangsu (CN); Yingxin Sun, Jiangsu (CN); Jia Guo, Jiangsu (CN); Tian Cao, Jiangsu (CN); Xiang Zhong, Jiangsu (CN)

(73) Assignee: NANJING SIXIN SCIENTIFIC-TECHNOLOGICA APPLICATION RESEARCH INSTITUTE CO., LTD., Jiangsu (CN)

(21) Appl. No.: 13/057,267

(22) PCT Filed: Sep. 1, 2010
(86) PCT No.: PCT/CN2010/076540

§ 371 Date: May 16, 2011

(30) Foreign Application Priority Data
Aug. 19, 2009 (CN) 200910184384.6

(51) Int. Cl. C08L 63/00

(52) U.S. Cl. 523/427

(57) ABSTRACT

A new-type papermaking wet-end defoamer and methods of making relating to the field of the chemical preparations for use in papermaking. The defoamer including 5˜99% FAME (fatty acid methyl ester) derivatives having a general structural formula of R¹CO(EO)ₓ(PO)_{y}OCH₃, molecular weight of 300˜3000 and a turbidity point of 20˜80° C.; which are the products of the addition reaction of FAME as an initiator and EO (ethylene oxide) and/or PO (propylene oxide) under the action of catalyst. The defoamer also including 0.1˜80% polyether having a general structural formula of R²{M(EO)ₘ(PO)ₙH}ₐ, a molecular weight of 500˜8000 and a turbidity point of 10˜80° C. The defoamer also including a 0.1˜70% modified polyether, with a general structural formula of R²{M(EO)ₘ(PO)ₙR³}ₐ. The defoamer also including 0.1˜20% natural oil and fat. The new-type papermaking wet-end defoamer is not only applicable to the papermaking wet-end process but also applicable to papermaking wastewater treatment and the elimination of other aqueous foam.

### PRIORITY CLAIM

The present application is a National Phase entry of PCT Application No. PCT/CN2010/076540, filed Sep. 1, 2010, the disclosure of which is hereby incorporated by reference herein in its entirety.

### FIELD OF THE INVENTION

The present invention relates to the preparation of a new-type papermaking wet-end defoamer. Defoamers are fine chemical additives, so accurately speaking, the preparation of a new-type papermaking wet-end defoamer relates to the field of the chemical preparations exclusively for papermaking.

### BACKGROUND OF THE INVENTION

Papermaking is a key industry of national economy. In the papermaking industry, a number of surfactants are often used. For example, various kinds of surfactants, such as sizing agent, retention aid, filter aid, reinforcing agent, deinking agent and dyes, may be used in papermaking wet-end according to different paper. They are prone to generating bubbles during the operation of paper machines. With the development of large-scale industry, the speed of paper machines is increasing. The speed of high-speed paper machines used in the current production has reached 1800 m/min. Generally, the papermaking white water in papermaking wet-end is used in a closed and circulated manner. In this process, if bubbles are not removed in time, “pits” will be formed on cardboards, affecting the evenness and tensile property of the paper.

According to the introduction of voluminous researches and references, papermaking wet-end bubbles exist mainly in three forms: the bubbles dispersed in white water; the tiny bubbles adsorbed on fiber surface; and the bubbles floating on the surface of white water. The major role of a papermaking wet-end defoamer is to peel off the bubbles adsorbed on the fine fiber at first. Then the tiny bubbles will merge into large bubbles. As the large bubbles have low density, they may easily float on water surface. Therefore, papermaking wet-end defoamer mainly has the effects of degassing and defoaming, and the former effect is more outstanding.

Many companies and research institutes at home and abroad go in for the research of papermaking wet-end defoamers, particularly in foreign countries. The defoamers mainly include bulk-type defoamers and emulsion-type defoamers. The emulsion type refers to fatty alcohol emulsion, and the bulk type refers to modified polyether.

Many bulk-type papermaking wet-end defoamers (water content is below 5%) are also introduced in patent documentations. For example, the papermaking wet-end defoamer introduced by in U.S. Pat. No. 5,320,777 to Nguyen et al. is mainly composed of the fatty alcohol with a β-ether bond structure, the fatty alcohol polyether with a high molecular weight and the block polyether with a low molecular weight; in U.S. Pat. No. 5,229,033 and U.S. Pat. No. 5,460,698, they also introduce a bulk-type defoamer comprising oleic diethanolamide and fatty alcohol (fatty acid) polyether; in U.S. Pat. No. 5,429,718 to Morlino introduces the defoaming performance of polyglyceryl fatty acid ester and particularly emphasizes the preferred conversion rate of esterification is 15˜85% and the preferred polymerization degree of polyglycerol is 3˜6. In U.S. Pat. No. 5,562,862 to Berzansky introduces a defoamer containing such components as fatty alcohol polyether, phthalate and polyisobutylene, wherein phthalate is a stabilizer and the main defoaming substance is fatty alcohol polyether; in U.S. Pat. No. 6,562,875 to Corbel introduces an aqueous defoamer for papermaking, which mainly contains fatty alcohol polyether and emulsifier; the two bulk-type papermaking defoamers introduced in Chinese Patent No. CN101130939 and Chinese Patent No. CN101158131 mainly contain fatty alcohol, fatty alcohol polyether and the polyether modified with ordinary groups. In brief, the bulk-type defoamers mainly contain fatty alcohol polyether. The defoamers mainly containing fatty alcohol polyether are sensitive to temperature and may generate defoaming effect only above cloud temperature. Mo reover, fatty alcohol is expensive and its ratio of performance to price is not high, so it also holds back the popularization of defoamers.

### SUMMARY OF THE INVENTION

The present invention is directed to a new-type wet-end defoamer in order to solve the problem of harmful foam during paper making production. Specifically, the present invention is directed to a defoamer comprising fatty acid methyl ester (“FAME”) and other ingredients.

FAME is the key component of biodiesel and made from renewable resources (such as rape seed oil, soybean oil, corn oil, cottonseed oil, peanut oil, sunflower seed oil, palm oil, coconut oil, recycled cooking oil and animal oil) through ester exchange reaction. It is a single substance or a mixture. The biodiesel prepared from FAME does not contain sulfur and arene and its cetane number is as high as 52.9. It is bio-degradable, nontoxic and harmless to environment. Compare d with ordinary diesel, it reduces air toxicity by 90% and cancer rate by 94% and is very safe during storage, use and transport due to its high open flash point.

FAME polyester, according to an embodiment of the present invention, is synthesized under the action of catalyst and by using FAME as the initiator, and through compounding with other components to generate a synergistic effect, solves the problem that presently available defoamers have poor defoaming and degassing performance at high temperature but provides a defoamer in which the used raw materials are renewable resources, cheap and environment friendly. Furthermore, the present invention saves human resource, material resource and other resources, greatly reduces production cost, and does not discharge any pollutants, thus has good economic and social benefits.

The new papermaking wet-end defoamer provided by an embodiment of the present invention is not only applicable to papermaking wet-end but also applicable to papermaking wastewater treatment and the elimination of other aqueous foam.

### DETAILED DESCRIPTION

A new-type papermaking wet-end defoamer comprising FAME derivatives, polyether, modified polyether, and natural oil, and of which the composition and ratio of each component in the new-type papermaking wet-end defoamer are described in details below:

(1) FAME derivatives

The general structural formula of the FAME derivatives is shown below:

R¹CO(EO)ₓ(PO)_{y}OCH₃ (1)

Wherein R¹ is a substituent group, a C₁₋₃₀ straight-chain or branched chain alkyl, including methyl, ethyl, propyl, isopropyl, butyl, isobutyl, amyl, hexyl or octyl. The FAME derivatives are the products of the addition reaction of FAME as an initiator and EO and/or PO under the action of catalyst. Th e suffixes x and y in the structural formula (1) denote the polymerization degree of EO and PO respectively and are integers in the range of 0˜150. The molecular weight of the FAME derivatives is 300˜3000 according to an embodiment of the present invention and can comprise 500˜2000 according to another embodiment of the present invention, and the turbidity point is 20˜80° C. according to an embodiment of the present invention, and can comprise 30˜60° C. according to an embodiment of the present invention.

The dose of the FAME derivatives in the new -type papermaking wet-end defoamer according to an embodiment of the present invention is 5˜99% of the total mass, and can comprise 30˜70% of the defoamer according to another embodiment of the present invention.

(2) Polyether

The general structural formula of polyether is shown below:

R²{M(EO)ₘ(PO)ₙH}ₐ (2)

Wherein M is a linking group, a bivalent group of —O— or —CO— or —N—, and —O— is preferred. R² is a substituent group, with a same selectable ran ge as R¹. P olyether is a product of the chemical reaction of an initiator, EO and PO. The preferred initiator of fatty alcohol polyether is a mono-functional initiator or a multi-functional initiator selected from methanol, ethanol, propanol, hexanol, octanol, dodecanol, octadecanol, eicosanol, docosanol, tetracosanol, octacosanol, glycol, propylene glycol and glycerol. The suffixes m and n denote the polymerization degree of EO and PO respectively and are integers in the range of 1˜150. According to an embodiment of the present invention, the value of suffix a is equal to or less than the number of the carbon atoms in R² and a≦3. The molecular weight of the polyether is 500˜8000 according to an embodiment of the present invention and 1000˜4000 according to an embodiment of the invention. The turbidity point is 10˜80° C. according to an embodiment of the present invention and can comprise 30˜60° C. according to another embodiment of the present invention.

The dose of the polyether in a new-type papermaking wet-end defoamer is 0.1˜80% of the total mass according to an embodiment of the present invention and can comprise 10˜50% of the defoamer according to an embodiment of the present invention.

(3) Modified polyether

The modified polyether is expressed with the following general formula:

R²{M(EO)ₘ(PO)ₙR³}ₐ (³)

Wherein the value ranges of R², M, m, n and a are same as those defined in Formula (2);

R³ is a capping group. According to the features of chemical reactions, capping groups are alkyl groups or acyl groups. The capping group here is an alkyl group or acyl group expressed with the following general structural formula:

CH₃(CH₂)ₚ(CO)_{q}— (4)

Wherein suffix p denotes the polymerization degree of —CH₂— and is an integer in the range of 1˜20; suffix q is 0 or 1, when q=0, it means that the capping group is an alkyl group, including methyl, ethyl, propyl, isopropyl, butyl or isobutyl, and methyl and butyl are preferred; when q=1, it means that the capping group is an acyl group, including acetyl, propionyl, butyryl, caprylyl, dodecanoyl, tetradecanoyl, palmitoyl or octadecanoyl, and dod ecanoyl and octadecanoyl are preferred.

The preparation of this modified polyether is completed in two steps in general. In the first step, polyether is synthesized; and in the second step, the synthesized polyether is capped and modified with capping material. If it is blocked with an alkyl group, the blocking will be completed with chloromethane or chlorobutane under the action of basic catalyst. Th e concrete implementation method can be found from the existing technical literature about patents. If it is blocked with an acyl group, fatty acid will be used as capping material. The fatty acid and polyether react under the action of basic catalyst to obtain a product. This technique can be easily found from the patent documentation in periodicals.

The dose of the modified polyether in a new-type papermaking wet-end defoamer is 0.1˜70% of the total mass according to an embodiment of the present invention and can comprise 10˜40% of the total mass according to another embodiment of the present invention.

(4) Natural oil

Natural oil is a mixture of esters combined from a glycerol and three fatty acids. The structural formula is shown below:

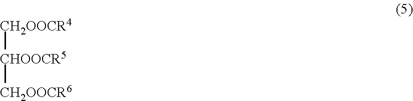

In this formula, R⁴, R⁵ and R⁶ can be same or different. They are saturated alkyl groups or unsaturated alkyl groups. The natural oil can be selected from rape seed oil, peanut oil, soybean oil, coconut oil, palm oil, cottonseed oil, castor oil, olive oil and beef tallow or a mixture thereof According to an embodiment of the present invention, rape seed oil, peanut oil and soybean oil are preferred for natural oil.

The dose of the natural oil in a new-type papermaking wet-end defoamer is 0.1˜20% of the total mass according to an embodiment of the present invention and can comprise 5˜10% of the total mass according to another embodiment of the present invention.

Method for Preparing the Defoamer

A new-type papermaking wet-end defoamer, according to an embodiment of the present invention is prepared by a method comprising at least mixing of FAME derivatives and polyether, mixing modified polyether into the derivative and polyether mixture, and adding natural oil to the mixture.

Method for Testing the Performance of the Defoamer

The performance of the defoamer can be determined by the circulating bubbling method. The equipment used is a portable circulating bubbling device. The instrument comprises a measuring cylinder, a circulating pump, a flow meter, a spray nozzle, automatic temperature control heater and other components and is same as the instrument introduced in the invention patent ZL 200410014870.0.

Defoamer performance testing method: firstly, put the prepared white water foam liquid into the circulating bubbling device, then turn on the temperature control switch, heat the foam liquid to the test temperature, switch on the air pump and stopwatch and record the time when the foam ascends to a specific height, and then add certain amount of the defoamer and record the change rule of foam height with time. In the beginning, the lower the foam falls, the faster the instantaneous defoaming speed of the defoamer will be. Later, the longer the time for reaching a same foam height is, the better the defoaming performance of the defoamer will be.

### EXAMPLES OF EMBODIMENTS OF THE PRESENT INVENTION

### Example 1

Preparation of FAME derivatives

| | R¹ | x | y |
|---|---|---|---|
| A-1 | CH₃(CH₂)₆CH═CH(CH₂)₈— | 16 | 3 |
| A-2 | CH₃(CH₂)₁₄— | 8 | 2 |
| A-3 | CH₃(CH₂)₁₆— | 6 | 0 |
| A-4 | CH₃(CH₂)₆CH═CH(CH₂)₈— | 0 | 0 |

### Example 2

Preparation of polyether

| | R² | M | m | n | a |
|---|---|---|---|---|---|
| B-1 | CH₃(CH₂)₇— | O | 27 | 48 | 1 |
| B-2 | C₃H₅O₃— | O | 10 | 15 | 3 |
| B-3 | CH₃(CH₂)₁₇— | O | 18 | 30 | 1 |

### Example 3

Preparation of modified polyether

| | R2 | M | m | n | a | R3 |
|---|---|---|---|---|---|---|
| C-1 | CH3(CH2)7— | O | 27 | 48 | 1 | Dodecanoyl |
| C-2 | C3H5O3— | O | 10 | 15 | 3 | Octadecanoyl |
| C-3 | CH3(CH2)17— | O | 18 | 30 | 1 | Octadecanoyl |

### Example 4

Natural oil

| | |
|---|---|
| D-1 | Soybean oil |
| D-2 | Castor oil |
| D-3 | Rapeseed oil |

### Example 5

Compound ratio of the defoamer (unit of the data in the table is mass percent, %)

| Raw material | | Defoamer A | Defoamer B | Defoamer C |
|---|---|---|---|---|
| FAME | A-1 | 0 | 20 | 0 |
| derivatives | A-2 | 0 | 0 | 15 |
| | A-3 | 0 | 10 | 15 |
| | A-4 | 60 | 40 | 10 |
| Polyether | B-1 | 15 | 0 | 0 |
| | B-2 | 0 | 10 | 10 |
| | B-3 | 0 | 0 | 15 |
| Modified | C-1 | 20 | 10 | 0 |
| polyether | C-2 | 0 | 5 | 10 |
| | C-3 | 0 | 0 | 20 |
| Natural | D-1 | 2 | 0 | 3 |
| oil | D-2 | 3 | 0 | 0 |
| | D-3 | 0 | 5 | 2 |

Determine defoamer performance in a laboratory by simulating the environment of papermaking white water for newsprint

Test equipment: Portable circulating bubbling device

Test temperature: 55° C.

Test air flow: 7 L/min

Defoamer dose: 4 μL

Test medium: Newsprint white water of a 400 KT/A high-speed paper machine.

Test result:

| | Foam height, ml | | | | |
|---|---|---|---|---|---|
| | Defoamer | Defoamer | Defoamer | Reference | Reference |
| Time (s) | A | B | C | sample 1 | sample 2 |
| 0 | 300 | 300 | 300 | 300 | 300 |
| 5 | 145 | 150 | 155 | 175 | 250 |
| 10 | 80 | 95 | 90 | 140 | 190 |
| 15 | 70 | 75 | 75 | 110 | 150 |
| 30 | 65 | 70 | 70 | 80 | 105 |
| 60 | 70 | 75 | 80 | 90 | 85 |
| 90 | 75 | 75 | 80 | 100 | 90 |
| 120 | 80 | 80 | 90 | 110 | 95 |
| 150 | 80 | 90 | 100 | 125 | 95 |
| 180 | 85 | 95 | 105 | 155 | 105 |
| 210 | 90 | 105 | 125 | 180 | 110 |
| 240 | 95 | 110 | 140 | 215 | 120 |
| 270 | 105 | 125 | 150 | 255 | 135 |
| 300 | 110 | 140 | 175 | 290 | 140 |
| 330 | 125 | 145 | 200 | 300 | 165 |
| 360 | 135 | 150 | 245 | | 180 |
| 390 | 145 | 160 | 300 | | 230 |
| 420 | 165 | 165 | | | 285 |

From the test result shown in the table above, it may be seen that the defoamer provided by the present invention has obviously higher defoaming speed and better defoaming performance than the reference defoamer does at 50° C.

1. A new-type papermaking wet-end defoamer comprising:
(1) FAME derivatives comprising 5 to 99% of the total mass of the defoamer and having a general structural formula of R¹CO(EO)ₓ(PO)_{y}OCH₃, wherein R¹ is a substituent group, a C₁₋₃₀ straight-chain or branched chain alkyl, wherein the suffixes x and y denote the polymerization degree of EO and PO respectively and are integers in the range of 0˜150;
(2) Polyether having a general structural formula of R²{M(EO)ₘ(PO)ₙH}ₐ, wherein M is a linking group, a bivalent group of —O— or —CO— or —N—; R² is a substituent group, a C₁₋₃₀ straight-chain or branched chain alkyl; the suffixes m and n denote the polymerization degree of EO and PO respectively and are integers in the range of 1˜150, wherein the value of suffix a is equal to or less than the number of carbon atoms in R²;
(3) Modified polyether with comprising 0.1 to 70% of the total mass of the defoamer and having a general structural formula of R²{M(EO)ₘ(PO)ₙR³}ₐ, wherein the value ranges of R², M, m, n and a are same as shown in the general structural formula of polyether; R³ is a capping group, an alkyl group or acyl group expressed with the following general structural formula: CH₃(CH₂)ₚ(CO)_{q}—, wherein suffix p denotes the polymerization degree of —CH₂— and is an integer in the range of 1˜20; suffix q is 0 or 1;
(4) Natural oil comprising 0.1 to 20% of the total mass of the defoamer, wherein the natural oil is selected from rape seed oil, peanut oil, soybean oil, coconut oil, palm oil, cottonseed oil, castor oil, olive oil and beef tallow and mixtures thereof.

2. The new-type papermaking wet-end defoamer according to claim 1, wherein the molecular weight of the FAME derivatives is 300˜3000, the turbidity point is 20˜80° C., and the FAME derivatives are the products of the addition reaction of FAME as an initiator and EO and/or PO under the action of catalyst.

3. The new-type papermaking wet-end defoamer according to claim 1, wherein the polyether is fatty alcohol polyether having a molecular weight of 500˜8000 and a turbidity point of 10˜80° C., wherein the initiator for preparation of the fatty alcohol polyether is selected from a group consisting of methanol, ethanol, propanol, hexanol, octanol, dodecanol, octadecanol, eicosanol, docosanol, tetracosanol, octacosanol, glycol, propylene glycol and glycerol.
